(19) United States
(12) Patent Application Publication
(10) Pub. No.: US 2025/0298667 A1
(43) Pub. Date: Sep. 25, 2025

(54) GRAPHICAL PROCESSING UNIT THROUGHPUT IMPROVEMENT USING ELEMENTARY FUNCTION UNIT OFFLOADING

(71) Applicant: QUALCOMM Incorporated, San Diego, CA (US)

(72) Inventor: Venkatesh K R, Vijayawada (IN)

(21) Appl. No.: 18/612,825

(22) Filed: Mar. 21, 2024

(51) Int. Cl. G06F 9/50; G06F 7/57

(52) U.S. Cl. CPC G06F 9/5038; G06F 7/57; G06F 9/5044

(57) ABSTRACT

Aspects of the disclosure are directed to graphical processing unit (GPU) throughput by selective offloading of EFU tasks to a plurality of arithmetic logic units (ALUs). In accordance with one aspect, the disclosure includes receiving an elementary function unit (EFU) task with a sequence of elementary function unit (EFU) native operations in a graphical processing unit (GPU); and determining if the EFU task can be offloaded from a plurality of elementary function units (EFUs) in the GPU to a plurality of arithmetic logical units (ALUs) in the GPU according to a selection criterion.

### TECHNICAL FIELD

This disclosure relates generally to the field of computer processor architecture, and, in particular, to a graphical processing unit (GPU) throughput in a system on a chip (SOC).

### BACKGROUND

An information processing system, for example, a computing platform, strives for high processing throughput and large main memory capacity. The information processing system may include a plurality of processing engines, each optimized for specific tasks. One processing engine known as a graphical processing unit (GPU) may be used for rendering graphical images for a wide range of user applications. The GPU may include a plurality of elementary function units (EFUs) and a plurality of arithmetic logical units (ALUs). GPU throughput may increase by selective offloading of EFU tasks to the plurality of ALUs.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides graphical processing unit (GPU) throughput by selective offloading of EFU tasks to a plurality of arithmetic logic units (ALUs). Accordingly, an apparatus including: a graphical processing unit (GPU) controller configured to control scene rendering; a plurality of elementary function units (EFUs) configured to execute a sequence of elementary function unit (EFU) native operations; and a plurality of arithmetic logical units (ALUs) configured to execute a sequence of arithmetic logical unit (ALU) native operations.

In one example, the sequence of EFU native operations includes one or more of the following: a power function, an exponential function, a logarithmic function, a trigonometric function, a square root function, a reciprocal function, or a reciprocal square function. In one example, the sequence of ALU native operations includes one or more arithmetic operations. In one example, the one or more arithmetic operations includes an addition operation, a subtraction operation or a multiplication operation.

In one example, the sequence of EFU native operations includes one or more of the following: a power function, an exponential function, a logarithmic function, a trigonometric function, a square root function, a reciprocal function, or a reciprocal square function. In one example, the sequence of ALU native operations includes one or more arithmetic operations. In one example, the one or more arithmetic operations includes an addition operation, a subtraction operation or a multiplication operation.

In one example, the apparatus further includes a graphical processing unit (GPU) network interface configured to receive an elementary function unit (EFU) task. In one example, the apparatus further includes a central processing unit (CPU) coupled to the graphical processing unit (GPU), the CPU configured to determine if the EFU task can be offloaded from the plurality of EFUs in the GPU to the plurality of ALUs in the GPU according to a selection criterion. In one example, the selection criterion is a determination of whether there are no arithmetic logical unit (ALU) native operations in a succession of N quantity of GPU instructions.

Another aspect of the disclosure provides an apparatus including: means for receiving an elementary function unit (EFU) task with a sequence of elementary function unit (EFU) native operations in a graphical processing unit (GPU); means for determining if the EFU task can be offloaded from a plurality of elementary function units (EFUs) in the GPU to a plurality of arithmetic logical units (ALUs) in the GPU according to a selection criterion; means for converting the sequence of EFU native operations in the EFU task into a sequence of arithmetic logical unit (ALU) native operations; and means for executing the sequence of ALU native operations to complete the EFU task.

Another aspect of the disclosure provides a method including: receiving an elementary function unit (EFU) task with a sequence of elementary function unit (EFU) native operations in a graphical processing unit (GPU); and determining if the EFU task can be offloaded from a plurality of elementary function units (EFUs) in the GPU to a plurality of arithmetic logical units (ALUs) in the GPU according to a selection criterion.

In one example, the EFU task includes a succession of N quantity of GPU instructions. In one example, the selection criterion is a determination of whether there are no arithmetic logical unit (ALU) native operations in a succession of N quantity of GPU instructions. In one example, the value of N depends on a type of an elementary function unit (EFU) native operation.

In one example, the selection criterion is successful. In one example, the method further includes converting the sequence of EFU native operations in the EFU task into a sequence of arithmetic logical unit (ALU) native operations. In one example, the method further includes executing the sequence of ALU native operations to complete the EFU task. In one example, the sequence of EFU native operations includes one or more of the following: a power function, an exponential function, a logarithmic function, a trigonometric function, a square root function, a reciprocal function, or a reciprocal square function. In one example, the sequence of ALU native operations includes one or more arithmetic operations. In one example, the one or more arithmetic operations includes an addition operation, a subtraction operation or a multiplication operation.

In one example, the selection criterion is failed. In one example, the method further includes executing the sequence of EFU native operations to complete the EFU task.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example graphical processing unit (GPU).

FIG. 3 illustrates an example flow diagram for selective offloading of an elementary function unit (EFU) task to an arithmetic logical units (ALUs).

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

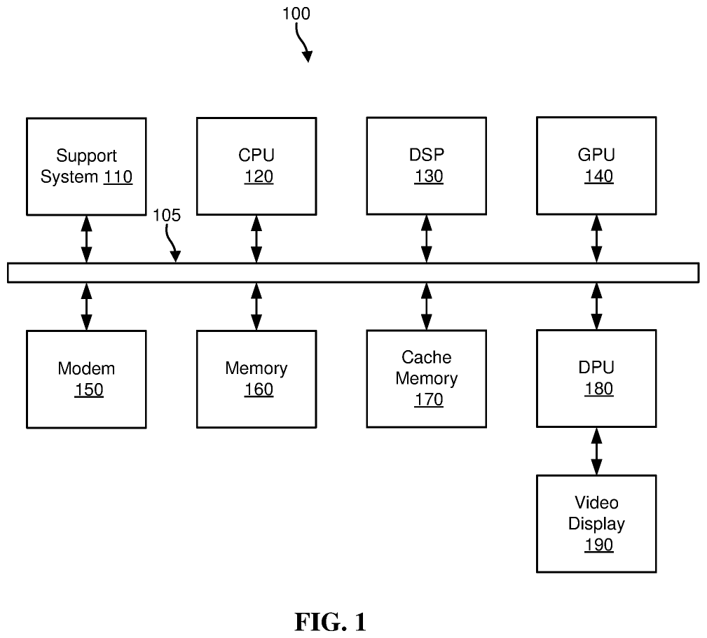

FIG. 1 illustrates an example information processing system 100. In one example, the information processing system 100 includes a plurality of processing engines, or processor cores, such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. For example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines. In one example, the information processing system 100 may be implemented on a system on a chip (SOC).

In one example, a user application which is executed on a system on a chip (SOC) may employ a GPU for graphics processing. For example, graphics processing may include scene rendering (e.g., 3D scene rendering) with intensity control, color composition, shading, etc. In one example, the GPU controller 240 controls the scene rendering, the color composition and/or the shading. In one example, the GPU may include a plurality of specialized modules for task execution. In one example, the GPU may include a plurality of elementary function units (EFUs) which execute specific operations (i.e., EFU native operations) such as a power function, an exponential function, a logarithmic function, a trigonometric function (e.g., cosine, sine, tangent, etc.), a square root function, a reciprocal function, a reciprocal square function, etc. In one example, the GPU may include a plurality of arithmetic logical units (ALUs) which execute arithmetic operations (i.e., ALU native operations) such as addition, subtraction, multiplication, etc.

In one example, the plurality of EFUs execute EFU tasks. For example, EFU tasks include executing EFU native operations. In one example, the plurality of ALUs execute ALU tasks. For example, ALU tasks include executing ALU native operations. In certain scenarios, EFU tasks may be executed by the plurality of ALUs using ALU native operations. In one example, EFU tasks specified in terms of EFU native operations may be translated into ALU native operations through a transformation. For example, the exponential function may be replaced by a product of base terms. For example, many functions may be approximated by a series of arithmetic operations (e.g., a Taylor series expansion of a function). For example, near zero, the cosine function of x may be approximated by a sum of 1 and a product of −½, x and x. For example, near zero, the sine function of x may be approximated by a sum of x and a product of −⅙, x, x, and x.

In one example, the GPU may have a higher quantity of ALUs than EFUs. In one example, the ALU instruction rate may be greater than the EFU instruction rate. In certain scenarios, it may be possible to overall GPU throughput performance by offloading some EFU tasks to the plurality of ALUs. In one example, the offloading includes translating EFU native operations into ALU native operations.

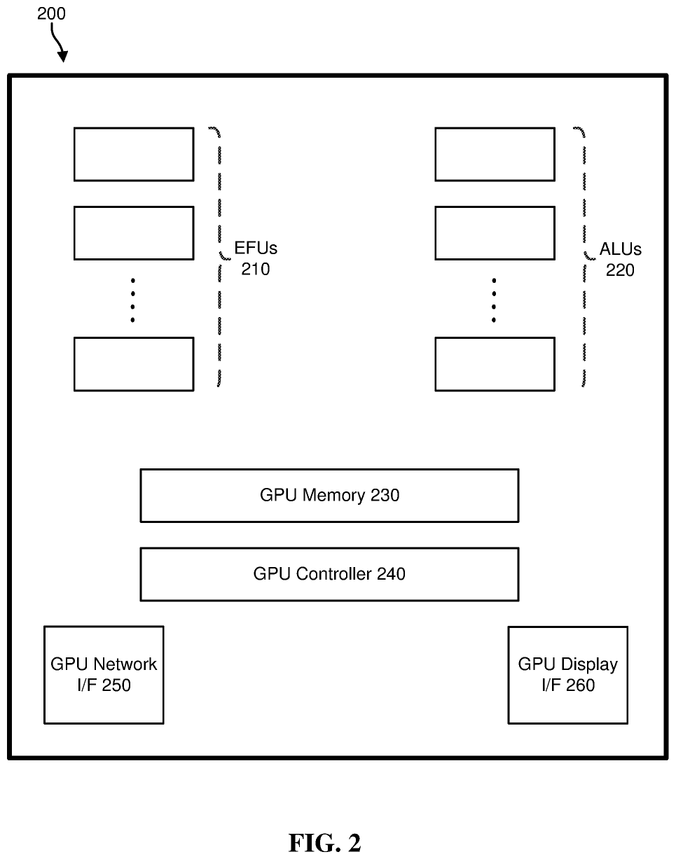

FIG. 2 illustrates an example graphical processing unit (GPU) 200. In one example, the GPU 200 includes a plurality of elementary function units (EFUs) 210, a plurality of arithmetic logical units (ALUs) 220, a GPU memory 230, a GPU controller 240, a GPU network interface 250 and a GPU display interface 260. In one example, the GPU 200 receives an EFU task over the GPU network interface 250 and stores the EFU task in the GPU memory 230. In one example, the GPU 200 executes the EFU task by executing EFU native operations in the plurality of EFUs 210. In one example, the GPU 200 executes the EFU task by executing a sequence of ALU native operations in the plurality of ALUs 220. In one example, the output of the EFU task may be image data sent to an external display via the GPU display interface 260.

In one example, a compiler in a processing engine, for example, a CPU, generates the EFU task by compiling a sequence of EFU native operations which are executed by the plurality of EFUs 210. In one example, the compiler translates a set of source language instructions into the sequence of EFU native operations. In one example, GPU 200 performance may be determined by the quantity of EFUs in the plurality of EFUs 210.

In one example, the power function y=xⁿ may be computed by using the logarithmic function and the exponential function. For example, the power function y=xⁿ is equivalent to log y=n log x, so the power function may be computed by first computing the product of n and log x and then taking the exponent of the product to determine y. In one example, if the GPU 200 supports 16 EFUs, since the power function may be computed with two EFU native operations, the GPU 200 throughput is 8 EFU native operations per instruction cycle.

In one example, the compiler may generate the EFU task by compiling a sequence of ALU native operations which are executed by the plurality of ALUs 220. In one example, the execution of ALU native operations by the plurality of ALUs 220 for the EFU task at a given time may be possible if the plurality of ALUs 220 are not being used for other tasks at the given time.

In one example, the EFU task specified in terms of EFU native operations may be instead translated into ALU native operations by offloading the EFU task to the plurality of ALUs. In one example, the offloading includes translating EFU native operations into ALU native operations. For example, the EFU native operations may be transformed into ALU native operations such as addition, subtraction and multiplication.

In one example, example pseudocode for the power function y=base^{exp}=power(base, exp) may be (note that the notation ! indicates a logical negation operator such that !0 means not equal to zero):
double result=1.0
while(exp!0) {
result=result*base;
exp=ex
p−1;
}

In one example, example assembly code for the power function y=base^{exp}=power(base, exp) may be:
Loop:
add.f r0.z, r0.z, (neg)(1.0); //exp=exp−1
mul.f r0.x, r0.x, r0.y; // result=result*base
cmps.f.ne p0.x, r0.z, (0.0); //exp!0
br p0.x, Loop

In one example, throughput of an EFU task depends on a quantity of instructions in a code loop. In the example pseudocode above, the power function has four instructions in the code loop. In one example, with a total of 128 ALUs in the plurality of ALUs, the ALU throughput for the power function is 32 (i.e., 128/4) ALU native operations per instruction cycle. In one example, with a total of 16 EFUs in the plurality of EFUs, the EFU throughput for the power function is 16 EFU native operations per instruction cycle. That is, in this example, the ALU throughput is greater than the EFU throughput by a factor of two.

In one example, the compiler may offload a EFU task from the plurality of EFUs to the plurality of ALUs. In one example, the offloading includes translating EFU native operations into ALU native operations. In one example, the compiler may select to offload the EFU task depending on a selection criterion. In one example, the selection criterion is a determination of whether there are no ALU native operations in a succession of N quantity of GPU instructions. If true, then the compiler will translate an EFU native operation into a plurality of ALU native operations. If true, the plurality of ALU native operations is executed by the plurality of ALUs. For example, an EFU native operation like pow.f32 r1, r2, r3 may be converted to an ALU native operation like pow.alu.f32 r1, r2, r3. In one example, the value of N depends on the type of EFU native operation. For example, for the power function example above, N is equal to four, that is four instructions in the code loop.

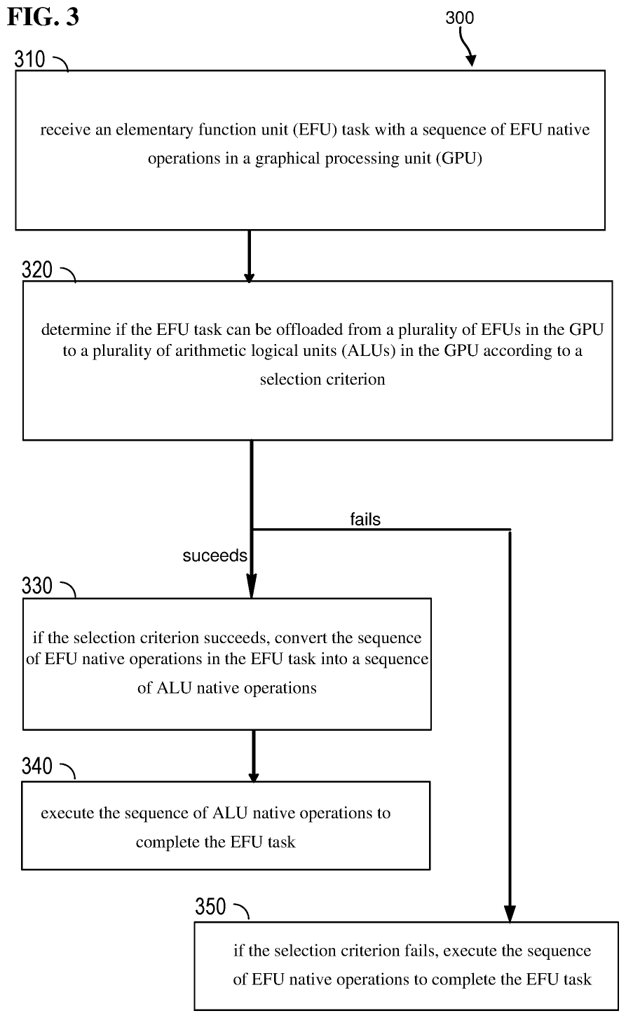

FIG. 3 illustrates an example flow diagram 300 for selective offloading of an elementary function unit (EFU) task to an arithmetic logical units (ALUs). In block 310, receive an elementary function unit (EFU) task with a sequence of EFU native operations in a graphical processing unit (GPU). In one example, an elementary function unit (EFU) task with a sequence of EFU native operations in a graphical processing unit (GPU) is received. In one example, the EFU task is received from main memory, another memory or a hardware unit.

In one example, the sequence of EFU native operations includes a power function, an exponential function, a logarithmic function, a trigonometric function (e.g., cosine, sine, tangent, etc.), a square root function, a reciprocal function, or a reciprocal square function, etc. In one example, the EFU task includes a succession of N quantity of GPU instructions. In one example, the succession of N quantity of GPU instructions is the sequence of EFU native operations. In one example, the sequence of EFU native operations is obtained from a translation of a set of source language instructions. In one example, the translation is performed by a compiler in a processing engine, for example, a central processing unit (CPU).

In block 320, determine if the EFU task can be offloaded from a plurality of EFUs in the GPU to a plurality of arithmetic logical units (ALUs) in the GPU according to a selection criterion. In one example, the EFU task can be offloaded from a plurality of EFUs in the GPU to a plurality of arithmetic logical units (ALUs) in the GPU according to a selection criterion is determined.

If the selection criterion succeeds, proceed to blocks 330 and 340. If the selection criterion fails, proceed to block 350. In one example, the selection criterion is a determination of whether there are no ALU native operations in the succession of N quantity of GPU instructions. In one example, the value of N depends on the type of EFU native operation. In one example, the determining is performed by the compiler in the processing engine, e.g., the CPU.

In block 330, if the selection criterion succeeds, convert the sequence of EFU native operations in the EFU task into a sequence of ALU native operations. In one example, the sequence of EFU native operations in the EFU task is converted into a sequence of ALU native operations if the selection criterion succeeds.

In one example, the success of the selection criterion occurs if there are no ALU native operations in the succession of N quantity of GPU instructions. In one example, the value of N depends on the type of EFU native operation. In one example, the sequence of ALU native operations is executed by the plurality of ALUs. In one example, the sequence of ALU native operations includes arithmetic operations. In one example, the sequence of ALU native operations includes one or more of the following operations: addition, subtraction, multiplication, etc.

In block 340, execute the sequence of ALU native operations to complete the EFU task. In one example, the sequence of ALU native operations is executed to complete the EFU task. In one example, execution of the sequence of ALU native operations is performed by the plurality of ALUs in the GPU.

In block 350, if the selection criterion fails, execute the sequence of EFU native operations to complete the EFU task. In one example, the sequence of EFU native operations is executed to complete the EFU task if the selection criterion fails. In one example, the failure of the selection criterion occurs if there is at least one ALU native operation in the succession of N GPU instructions. In one example, the value of N depends on the type of EFU native operation. In one example, the sequence of EFU native operations is executed by the plurality of EFUs. In one example, the sequence of ELU native operations includes a power function, an exponential function, a logarithmic function, a trigonometric function (e.g., cosine, sine, tangent, etc.), a square root function, a reciprocal function, a reciprocal square function, etc.

In one aspect, one or more of the steps for providing graphical processing unit (GPU) throughput by selective offloading of EFU tasks to a plurality of arithmetic logic units (ALUs). in FIG. 3 may be executed by one or more processors which may include hardware, software, firmware, etc. The one or more processors, for example, may be used to execute software or firmware needed to perform the steps in the flow diagram of FIG. 3. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising:
a graphical processing unit (GPU) controller configured to control scene rendering;
a plurality of elementary function units (EFUs) configured to execute a sequence of elementary function unit (EFU) native operations; and
a plurality of arithmetic logical units (ALUs) configured to execute a sequence of arithmetic logical unit (ALU) native operations.

2. The apparatus of claim 1, wherein the sequence of EFU native operations includes one or more of the following: a power function, an exponential function, a logarithmic function, a trigonometric function, a square root function, a reciprocal function, or a reciprocal square function.

3. The apparatus of claim 1, wherein the sequence of ALU native operations includes one or more arithmetic operations.

4. The apparatus of claim 3, wherein the one or more arithmetic operations includes an addition operation, a subtraction operation or a multiplication operation.

5. The apparatus of claim 1, further comprising a graphical processing unit (GPU) network interface configured to receives an elementary function unit (EFU) task.

6. The apparatus of claim 5, further comprising a central processing unit (CPU) coupled to the graphical processing unit (GPU), the CPU configured to determine if the EFU task can be offloaded from the plurality of EFUs in the GPU to the plurality of ALUs in the GPU according to a selection criterion.

7. The apparatus of claim 6, wherein the selection criterion is a determination of whether there are no arithmetic logical unit (ALU) native operations in a succession of N quantity of GPU instructions.

8. An apparatus comprising:
means for receiving an elementary function unit (EFU) task with a sequence of elementary function unit (EFU) native operations in a graphical processing unit (GPU);
means for determining if the EFU task can be offloaded from a plurality of elementary function units (EFUs) in the GPU to a plurality of arithmetic logical units (ALUs) in the GPU according to a selection criterion;
means for converting the sequence of EFU native operations in the EFU task into a sequence of arithmetic logical unit (ALU) native operations; and
means for executing the sequence of ALU native operations to complete the EFU task.

9. A method comprising:
receiving an elementary function unit (EFU) task with a sequence of elementary function unit (EFU) native operations in a graphical processing unit (GPU); and
determining if the EFU task can be offloaded from a plurality of elementary function units (EFUs) in the GPU to a plurality of arithmetic logical units (ALUs) in the GPU according to a selection criterion.

10. The method of claim 9, wherein the EFU task includes a succession of N quantity of GPU instructions.

11. The method of claim 9, wherein the selection criterion is a determination of whether there are no arithmetic logical unit (ALU) native operations in a succession of N quantity of GPU instructions.

12. The method of claim 11, wherein the value of N depends on a type of an elementary function unit (EFU) native operation.

13. The method of claim 12, wherein the selection criterion is successful.

14. The method of claim 13, further comprising converting the sequence of EFU native operations in the EFU task into a sequence of arithmetic logical unit (ALU) native operations.

15. The method of claim 14, further comprising executing the sequence of ALU native operations to complete the EFU task.

16. The method of claim 15, wherein the sequence of EFU native operations includes one or more of the following: a power function, an exponential function, a logarithmic function, a trigonometric function, a square root function, a reciprocal function, or a reciprocal square function.

17. The method of claim 16, wherein the sequence of ALU native operations includes one or more arithmetic operations.

18. The method of claim 17, wherein the one or more arithmetic operations includes an addition operation, a subtraction operation or a multiplication operation.

19. The method of claim 9, wherein the selection criterion is failed.

20. The method of claim 19, further comprising executing the sequence of EFU native operations to complete the EFU task.
